(19) United States
(12) Patent Application Publication
(10) Pub. No.: US 2019/0047041 A1
(43) Pub. Date: Feb. 14, 2019

(54) USE OF A COMPOSITION AS A BINDER COMPONENT FOR PRODUCING FEEDER ELEMENTS ACCORDING TO THE COLD BOX PROCESS, CORRESPONDING METHOD, AND FEEDER ELEMENTS

(71) Applicant: HÜTTENES-ALBERTUS CHEMISCHE WERKE GESELLSCHAFT MIT BESCHRÄNKTER HAFTUNG, Düsseldorf (DE)

(72) Inventors: Gérard LADÉGOURDIE, Düsseldorf (DE); Sandra LEHMANN, Potsdam (DE); Hermann LIEBER, Langenhagen (DE); Klaus RIEMANN, Wunstorf (DE); Nils ZIMMER, Garbsen (DE); Jürgen HÜBERT, Langenhagen (DE); Markus DÖRSCHEL, Köln (DE); Bernd DONNER, Langenfeld (DE); Ursula NITSCH, Boppard (DE)

(73) Assignee: HÜTTENES-ALBERTUS CHEMISCHE WERKE GESELLSCHAFT MIT BESCHRÄNKTER HAFTUNG, Düsseldorf (DE)

(21) Appl. No.: 16/079,336

(22) PCT Filed: Feb. 17, 2017
(86) PCT No.: PCT/EP2017/053620

§ 371 Date: Aug. 23, 2018

(30) Foreign Application Priority Data
Feb. 23, 2016 (DE) 10 2016 202 795.6

(51) Int. Cl. B22C 1/22; C08L 61/06; C08L 75/04; C08K 5/095; C08K 5/42; C08K 5/521; C08K 3/40

(52) U.S. Cl. CPC B22C 1/2253; B22C 1/2273; C08L 61/06; C08K 3/40; C08K 5/095; C08K 5/42; C08K 5/521; C08L 75/04

(57) ABSTRACT

A description is given of a use of a composition comprising an ortho-fused phenolic resole in an amount of up to 60 wt %; as first solvent for the ortho-fused phenolic resole, one or more compounds selected from the group consisting of alkyl silicates, alkyl silicate oligomers and mixtures thereof, the total amount of these compounds being greater than 30 wt %; optionally one or more further solvents for the ortho-fused phenolic resole; optionally one or more further additives; the weight percentages being based on the total amount of the composition, as a binder component for producing feeder elements by the cold box process. A description is also given of the use of a two-component binder system for producing feeder elements by the cold box process, and of a method for producing a feeder element for the foundry industry, and also of a feeder element.

The present invention relates to the use of a composition as a binder component for producing feeder elements by the cold box process, to the use of a corresponding two-component binder system for producing feeder elements by the cold box process, to a corresponding method and to a corresponding feeder element. The invention is defined in the appended claims and in the corresponding passages of the description.

The term “feeder element” in the context of the present documents encompasses feeder surrounds, feeder sleeves and feeder caps and also heating pads. A feeder element may comprise metallic or semimetallic materials whose purpose is to undergo ignition and exothermic reaction when the feeder is in use (such materials are frequently aluminum, magnesium and/or silicon); such elements are then said to be “exothermic feeder elements”. Alternatively, a feeder element may be free from relevant amounts of such metallic or semimetallic materials; in that case, it is said to be an “insulating feeder element”.

In foundry work, feeders are produced by using a binder to bind a molding mixture. Such binders comprise, for example, inorganic binder systems with or without additional crosslinking components, swellable binders, plastics polymers and cold box binders. The selection of the binder system and its constituents are critically dependent on the way in which the feeders are produced, their field of use, and any further requirements specific to the application.

The binders may comprise organic and/or inorganic constituents.

Inorganic binder systems here in certain cases comprise esters of orthosilicic acid ((SiOH)₄). The use of such esters in silicatic binder systems, however, leads frequently to a decidedly low elasticity (i.e., flexural strength) on the part of the resulting feeder elements, thereby limiting their usefulness.

Organic binders in the cold box process offer diverse advantages, such as sudden catalytic curing, for example, which ensures a high initial hardness for the feeder and hence ensures reliable handling during production. Moreover, feeders which have been produced by means of a cold box process exhibit high dimensional integrity; they can therefore be manufactured in geometrically complicated designs.

The use of cold-box-bound feeders in foundry work itself also offers numerous advantages. The high strengths and high elasticities are likewise advantageous here, as are the high moisture resistance and high contour accuracy. Because the cold box system is an organic-based system, however, the casting of the feeders inevitably entails development of fumes and of emissions.

Because of the greater elasticity (modulus of elasticity) of the cold box system and resultant lower brittlenesses by comparison with the silicatic binder system, it is possible to manufacture what are called “telescopic feeders”, where “two molding elements [ . . . ] of the feeder sleeve [can be] slid telescopically into one another” (cf. EP 1 184 104 A1, paragraph [0046]).

A disadvantage when using cold box binders, however, are the emissions of fumes, CO₂, odor and BTX when a feeder bound accordingly is cast, owing to the high fraction of polyurethane in the binder system. The emissions of benzene and toluene when heating a binder system based on a polyurethane, and the problems resulting from this, are discussed for foundry molds and foundry cores in EP 1 057 554 B1, for example (cf. example 5 and paragraph [0013]).

Reducing such emissions is desirable on grounds of health and the environment. EP 1 057 554 B1 discloses the use of solvents based on the esters of orthosilicic acid in cold box binder systems for producing molds and cores in the foundry industry.

Feeders, however, as described above, are subject to particular requirements, which differ very markedly from the requirements asked of foundry molds and foundry cores.

This is especially true of exothermic feeder materials which comprise refractory fillers, oxidants, and ignitors.

Within the foundry industry, there has therefore been a demand for some considerable time for cold-box-bound feeders which exhibit reduced pollutant emissions on casting of the feeder but whose mechanical properties are not adversely affected. In this context, preferably, one or more properties from the group of modulus of elasticity, strength, gas permeability, ignition time, firing time and feeding behavior ought not to be adversely affected. Correspondingly, there is a demand for binders for producing such feeders.

The literature has already disclosed a variety of binder systems, including cold box binder systems among them:

EP 0 804 980 B1 relates to “Feeder inserts and production thereof” (title). It discloses polyurethane-based binders (cf. page 2, line 43).

EP 1 057 554 B1 relates to a “Binder system for molding mixtures for producing molds and cores” (title). It discloses polyurethane-based binder systems for the cold box process and for the polyurethane no-bake process (cf. paragraph [0001]).

DE 100 65 270 A1 relates to “Feeders and compositions for producing them” (title). As “phenolic resin component for use in the cold box process”, a composition made up of “phenol resole in rapeseed oil methyl ester” is disclosed (cf. paragraph [0042]).

DE 101 04 289 A1 relates to “Moldable exothermic compositions and feeders made thereof” (title). “Waterglass, a synthetic resin (e.g., for use in the cold box process) or starch” are disclosed as binders (cf. paragraph [0008]).

DE 10 2008 055 042 A1 relates to “Modified phenolic resins” (title). It discloses the “use of a modified phenolic resin as binder or binder constituent”, “where the modified phenolic resin comprises phenolic resin units which are substituted and/or linked by esters of orthosilicic acid [ . . . ]” (cf. claim 1).

WO 2012/097766 A2 relates to “Binder based on polyurethane for producing cores and molds using isocyanates containing a urethonimine and/or carbodiimide group, a mold material mixture containing said binder, and a method for using said binder” (title). Solvents disclosed for the phenolic resin are, in particular, “dicarboxylic esters, glycol ether esters, glycol diesters, glycol diethers, cyclic ketones, cyclic esters (lactones), cyclic carbonates or silicic esters” (cf. page 8, last complete paragraph).

WO 2013/117256 relates to “Cold-box binder systems and mixtures for usage as additives for such binder systems” (title). Example 3 (see page 24) uses tetraethyl silicate, DBE (“Dibasic Ester”) and epoxy silane in a phenolic resin solution. Example 4, in a solution containing polyisocyanate, uses tetraethyl silicate, dioctyl adipate and acyl chloride.

WO 2012/080454 relates to a “Low-emission cold-setting binder for the foundry industry” (title). Organic binders used are polyurethane binders, furan resin binders and epoxy-acrylate binders (see page 3, 2^{nd} complete paragraph).

EP 2 052 798 B1 relates to a “Binder composition of alkaline phenol aldehyde resole resins” (title). Specific polyalkylene glycols are disclosed as solvents for binder systems (cf. paragraph [0030]).

EP 0 177 871 A2 relates to “Polyurethane binder compositions and process for their preparation” (title). Various solvents are disclosed, for example, for cold box or no-bake processes (cf. page 13).

WO 2008/113765 A1 relates to “Core-sheath particles for use as a filler for feeder masses” (title). The bulk density of the particles used as carrier cores here is “preferably in the range from 85 g/L to 500 g/L” (cf. page 6, line 12). Cold box binders are disclosed as preferred binders (cf. page 8, line 18).

EP 1 728 571 A1 relates to an “Insulating feeder and method for producing same” (title). The ceramic hollow spheres used in the insulating feeders disclosed here possess a bulk density of less than 0.5 g/cm³, and the density of the insulating feeders is preferably less than 0.6 g/cm³ (cf. paragraph [0031]).

EP 1 050 354 A1 relates to a “Moldable exothermic composition and feeder made therefrom” (title). The substances present in the exothermic compositions have a bulk density of less than 0.5 g/cm³ (cf. paragraph [0022]). Binders disclosed are waterglass, phenol-formaldehyde resin, polyurethane resin, and starch (cf. paragraph [0023]).

Reference may also be made to DE 10 2015 201 614 A1 (“Two-component binder system for the polyurethane cold box process”) and DE 20 2011 110 579 U1 (“Binder containing sulfonic acid for molding mixtures for producing molds and cores”).

A large number of feeder compositions are already known from the prior art discussed above. In these compositions, diverse feeder molding mixtures are combined with diverse binders (organic or inorganic).

A primary object of the present invention was to specify a binder system or a binder component enabling the production of a feeder sleeve which, when used in foundry work, is accompanied by particularly low emissions of pollutants.

A further object of the present invention was to specify such a binder system or such a binder component enabling production of a feeder sleeve having a low density, the intention being that the feeder sleeve produced should possess a high flexural strength.

A binder system or a binder component achieving all of the aforesaid qualities has been hitherto unknown in the art.

The binder system and binder component to be specified ought preferably to be compatible with the more recently developed lightweight fillers, of the kind used in the existing feeder elements with a density of less than 1 g/cm³, more particularly with a density of less than 0.7 g/cm³.

A further object of the present invention was to specify corresponding methods for producing feeder elements, and also corresponding feeder elements, especially exothermic feeder elements or insulating (non-exothermic) feeder elements.

The primary object set with regard to the use to be specified is achieved in accordance with the invention through the use of a composition comprising
an ortho-fused phenolic resole in an amount of up to 60 wt %, preferably in an amount of 40 wt % to 60 wt %,
as first solvent for the ortho-fused phenolic resole, one or more compounds selected from the group consisting of alkyl silicates, alkyl silicate oligomers and mixtures thereof, the total amount of these compounds being greater than 30 wt %,
optionally one or more further solvents for the ortho-fused phenolic resole,
optionally one or more further additives,
   the weight percentages being based on the total amount of the composition,
   as a binder component for producing feeder elements by the cold box process,
   preferably
   as a binder component for producing feeder elements with reduced emission of pollutants on casting.

Preferred in accordance with the invention is the use of a composition comprising
an ortho-fused phenolic resole in an amount of 40 wt % to 60 wt %, preferably in an amount of 50 to 60 wt %,
as first solvent for the ortho-fused phenolic resole, one or more compounds selected from the group consisting of alkyl silicates, alkyl silicate oligomers and mixtures thereof, the total amount of these compounds being greater than 30 wt %,
optionally one or more further solvents for the ortho-fused phenolic resole,
optionally one or more further additives,
   the weight percentages being based on the total amount of the composition,
   as a binder component for producing feeder elements by the cold box process.

The expression “ortho-fused phenolic resole” denotes a phenolic resin whose molecules comprise aromatic rings formed of phenol monomers and linked in ortho-position by methylene ether bridges, and terminal methylol groups arranged in ortho-position.

The ortho-fused phenolic resole used in accordance with the invention may alternatively be an ortho-fused phenolic resole having etherified and/or free methylol groups. The expression “ortho-fused phenolic resole having etherified and/or free methylol groups” here denotes an “ortho-fused phenolic resole” whose molecules comprise
(a1) (a1-i) aromatic rings resulting from phenol monomers,
   (a1-ii) linked in ortho-position by methylene ether bridges
      and
(b1) (b1-i) etherified and/or free methylol groups,
   (b1-ii) arranged in ortho-position
      (cf. also formula I).

The term “ortho-position” denotes the ortho-position in relation to the hydroxyl group of the phenol. This is not to rule out the additional presence, in the molecules of the ortho-fused phenolic resoles for use in accordance with the invention, of
(a2) aromatic rings linked by methylene groups (as well as aromatic rings (a1) linked by methylene ether bridges)
   and/or
(b2) terminal hydrogen atoms in ortho-position (as well as terminal methylol groups in ortho-position (b1)).

Particularly preferred ortho-fused phenolic resoles here are ortho-fused phenolic resoles having etherified and/or free methylol groups as represented schematically in the following general formula I:

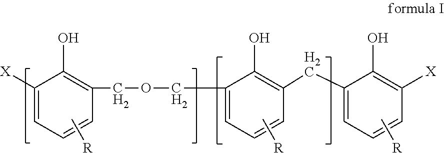

In formula I, R is hydrogen or a substituent in meta- or para-position to the phenolic hydroxyl group, preferably from the group consisting of methyl, n-butyl, isobutyl, tert-butyl, octyl, nonyl, and also (as result when using cardanol) pentadecenyl, pentadecadienyl and pentadecatrienyl; there may also be two radicals R arranged on one aromatic ring, the definitions of these radicals in that case being independent of one another; the sum of m and n is at least 2, and the ratio m/n is at least 1. X is hydrogen, CH₂OH (methylol group, resulting from the reaction of formaldehyde) or an etherified methylol group (resulting from the reaction of formaldehyde in the presence of an alcohol).

The term “phenol monomers” here embraces preferably both unsubstituted phenol (C₆H₅OH) and substituted phenols, as for example o-cresol, m-cresol, p-cresol, p-butylphenol, p-octylphenol, p-nonylphenol, and cardanol; of these “phenol monomers”, preference is given to phenol (C₆H₅OH), o-cresol and cardanol, and particular preference to phenol (C₆H₅OH).

Further, specific, nonlimiting examples of particularly suitable “phenol monomers” are 3,5-xylenol, 3,4-xylenol, 2,3,4-trimethylphenol, 3-ethylphenol, 3,5-diethylphenol, p-butylphenol, 3,5-dibutylphenol, p-amylphenol, p-cyclohexylphenol, p-octylphenol, 3,5-dicyclohexylphenol, p-phenylphenol, p-crotylphenol, 3,5-dimethoxyphenol, p-ethoxyphenol, p-butoxyphenol, 3-methyl-4-methoxyphenol, and p-phenoxyphenol.

Alkyl-substituted phenol monomers, and especially the aforementioned specific phenol monomers, can be dissolved in particularly large amounts in a first solvent as described above. The use of the resulting compositions as a binder component for producing feeder elements by the cold box process results in feeder elements having a flexural strength suitable for practical use.

The term “ortho-position” denotes the ortho-position in relation to the hydroxyl group of the phenol. This is not to rule out the additional presence, in the molecules of the ortho-fused phenolic resoles for use in accordance with the invention, of aromatic rings linked by methylene groups (as well as aromatic rings (a) linked by methylene ether bridges) and/or of terminal hydrogen atoms in ortho-position (as well as terminal methylol groups in ortho-position (b)).

In the molecules of the ortho-fused phenolic resoles for use in accordance with the invention, the ratio of methylene ether bridges to methylene bridges is preferably at least 1, and the ratio of terminal methylol groups in ortho-position to terminal hydrogen atoms in ortho-position is likewise at least 1.

Phenolic resins of this kind are also referred to as benzyl ether resins. They are preferably obtainable by polycondensation of formaldehyde (optionally in the form of paraformaldehyde) and phenols in molar ratio of greater than 1:1 to 2:1, preferably 1.23:1 to 1.5:1, catalyzed by divalent metal ions (preferably Zn²⁺) in a weakly acidic medium. The skilled person is familiar with the synthesis steps.

In a phenolic resin component of a cold box binder, ortho-fused phenolic resoles, i.e., benzyl ether resins, are used customarily in conjunction with an organic or inorganic solvent, and hence in the form of a solution, in order to set suitably the viscosity of the resultant phenolic resin composition for mixing with a molding material. Further additives in a phenolic resin composition comprising an ortho-fused phenolic resole in certain cases also include other resins, novolacs being an example. The above details concerning one or more further additives are also valid for the present invention.

Customarily, in practice, mixtures of solvents are used, having been tailored to the particular binder system (phenolic resin and polyisocyanate).

In the present invention, the term “solvent” is also understood to include those compounds which do not just serve exclusively to dissolve or dilute another compound but which also react at least partly with constituents of a composition as described above, i.e., which modify the constituents of the composition. This is especially relevant because, customarily, the modification of one or more ortho-fused phenolic resoles in a composition used in accordance with the invention by one or more solvents results in an increase in the dissolved fraction of the modified ortho-fused phenolic resoles in the composition. The compounds selected as solvents for the ortho-fused phenolic resole ought preferably, however, to be present very largely in unreacted form, and hence should not react with a constituent (e.g., an ortho-fused phenolic resole) or additive of a composition as described above.

In the context of the present invention, the term “binder (component)” is applied preferably to those substances which join or bond solids with a fine degree of division (e.g., powders) to one another. The binder component is preferably in liquid form.

In the context of the present invention, the term “cold box processes” is applied preferably to those processes for producing feeders that in principle use cold molds—that is, molds which are not heated or hot—for feeder production. Frequently in this case a polyurethane-based cold box process is used, in which an isocyanate component is employed with a phenolic resin component comprising an ortho-fused phenolic resole.

Specified below—beginning with the preferred tetraalkyl silicates—are a series of particularly preferred (and optionally substituted) alkyl (ortho)silicates:
tetraalkyl silicates: tetraethyl (ortho)silicate; tetra-n-propyl silicate
trialkyl silicates: triethyl silicate; trialkyl silicates (especially triethyl silicates) with aryl functionality on the fourth oxygen atom (Si—O—Ar; Ar=aryl radical)
dialkyl silicates: diethyl silicate; dialkyl silicates with aryl functionality on the third and/or fourth oxygen atom (Si—O—Ar)
monoalkyl silicates: monoethyl silicate; monoalkyl silicates with aryl functionality on the second and/or third and/or fourth oxygen atom (Si—O—Ar) substituted silicates: (a) aryl- or alkyl-alkoxy-silanes, i.e., compounds of type R¹ₙ₌₁₋₃Si(OR²)ₘ₌₄₋ₙ with R¹=alkyl or aryl radical and R²=alkyl radical; e.g., dimethyl-dimethoxy-silane (R¹=CH₃; n=2; R²=CH₃; m=4-n=2);
   (b) organofunctional silanes, i.e., compounds of type R¹ₙ₌₁₋₃Si(OR²)ₘ₌₄₋ₙ with R¹ being a functional group such as 3-aminopropyl or 3-ureidopropyl or 3-glycidyloxypropyl and R²=alkyl radical; e.g., 3-aminopropyltriethoxysilane, 3-ureidopropyltriethoxysilane or 3-glycidyloxypropyl-trimethoxysilane.

Surprisingly, with the inventive use of a composition as a binder component as described above, it has been found that emissions of odor and of fumes during casting of the melt are reduced with the feeder elements produced by the cold box process. Reducing emissions in this way is at the focal point of continual processes of optimization in foundry work, on grounds of health and the environment. The feeder elements produced by the cold box process, as described above, nevertheless do not suffer from reduced flexural strength, in spite of the use of the compounds selected as first solvent for the ortho-fused phenolic resole.

A cold box system based on polyurethane consists in general of two components. The first component, the phenolic resin component, is frequently an ortho-fused phenolic resole, and the second, a polyisocyanate component, is preferably methylenediphenyl diisocyanate. The phenolic resin component is dissolved in a first solvent and optionally further solvents, to set a viscosity suitable for processing. For this reason, in the composition used in accordance with the invention, as described above, it is common to add the solvent DBE (trade name “Dibasic Ester” from DuPont) as well to the first solvent.

In a preferred use as defined above, the composition comprises
as first solvent for the ortho-fused phenolic resole, one or more compounds selected from the group consisting of alkyl silicates, alkyl silicate oligomers and mixtures thereof, the total amount of these compounds being greater than 30 wt %,
optionally one or more further solvents for the ortho-fused phenolic resole,
and
optionally one or more further additives,
   the ratio by mass of the total amount of first solvent to the total amount of further solvents and further additives being at least greater than 1, preferably at least greater than 2.

When used as a binder component, an advantage of the composition described above is that the composition thus produced has particularly good processing qualities, more particularly being highly miscible with the other components of the binder system and of the feeder element to be produced. In our own investigations, moreover, with a mass ratio of the total amount of first solvent to the total amount of further solvents and further additives of at least greater than 1, preferably greater 2, an outstanding reduction was achieved in the emissions during casting, whereas the flexural strength of the feeder element produced was influenced only negligibly.

The composition used in accordance with the invention here preferably comprises a total amount of compounds as first solvent for the ortho-fused phenolic resole in the range from greater than 30 wt % to 60 wt %, more preferably 35 wt % to 60 wt %, very preferably 35 wt % to 50 wt %.

Particularly preferred is a use (as defined above, preferably as defined above as preferable) wherein the composition comprises
as first solvent for the ortho-fused phenolic resole, one or more alkyl silicates, the total amount of these alkyl silicates being greater than 30 wt % and preferably being 35 wt % or more, based on the total amount of the composition,
   and preferably
as first solvent for the ortho-fused phenolic resole, one or more tetraalkyl silicates, the total amount of these tetraalkyl silicates being greater than 30 wt % and preferably being 35 wt % or more, based on the total amount of the composition.

Alkyl silicates, especially tetraalkyl silicates, are advantageous as a first solvent for the ortho-fused phenolic resole because the presence of alkyl groups means that a particularly large fraction of the ortho-fused phenolic resole can be dissolved and at the same time the pollutant emissions on casting of the melt in a feeder produced with the above-described composition can be reduced, in comparison to other solvents from the prior art.

Particularly preferred is a use (as defined above, preferably as defined above as preferable) wherein the composition comprises
as first solvent for the ortho-fused phenolic resole, tetraethyl silicates, the total amount of these tetraethyl silicates being greater than 30 wt % and preferably being at least 35 wt % or more, based on the total amount of the composition.

Tetraalkyl silicate as first solvent for the ortho-fused phenolic resole (or as a constituent of the first solvent) has the advantage that, because of the ratio of carbon atoms to silicon atoms, it results in a largely reduced emission of pollutants yet in conjunction with sufficient flexural strength on the part of the feeder elements produced with the above-described composition. Moreover, tetraalkyl silicates are available on a particularly favorable basis on the market.

Particular preference is given to a use (as defined above, preferably as defined above as preferable or more preferable) wherein the composition comprises
the ortho-fused phenolic resole in an amount of 40 to 60 wt %, preferably 50 to 60 wt %, based on the total amount of the composition.

The use in this way of a composition with at least 40 wt % of ortho-fused phenolic resole, preferably at least 50 wt % of ortho-fused phenolic resole, has the advantage that the resulting compositions lead to feeder elements which exhibit an advantageously increased flexural strength.

Particular preference is given to a use (as defined above, preferably as defined above as preferable or more preferable) wherein the composition comprises one or more further solvents for the ortho-fused phenolic resole, selected from the group consisting of
mixtures of dialkyl esters (preferably dimethyl esters) of C₂ to C₆ dicarboxylic acids, preferably of dimethyl esters of C₄ to C₆ dicarboxylic acids (such mixtures are known to the skilled person as “dibasic esters” or “DBE”),
monoesters of fatty acids with a carbon chain of 12 or more C atoms, preferably alkyl monoesters, more preferably methyl monoesters and/or butyl monoesters (for example, the methyl monoesters, described in our own EP 0 771 559 A1, of one or more fatty acids with a carbon chain of 12 or more C atoms, thus rapeseed oil methyl ester, for example),
   and
propylene carbonate (4-methyl-1,3-dioxolane-2-one).

Preferred C₂ to C₆ dicarboxylic acids in the context of the present invention are, for example, 1,2-ethanedioic acid (oxalic acid, C₂ dicarboxylic acid), 1,3-malonic acid, 1,4-butanedioic acid (succinic acid, C₄ dicarboxylic acid) or 1,6-hexanedioic acid (adipic acid, C₆ dicarboxylic acid).

An advantage of using the above-described further solvents for the ortho-fused phenolic resole is that the resultant composition allows particularly favorable processing and particularly eco-friendly production of feeder elements.

Particular preference is given to a use (as defined above, preferably as defined above as preferable or more preferable) wherein the composition comprises a total amount of solvents for the ortho-fused phenolic resole in the range from 40 to 60 wt %, preferably a total amount in the range from 40 to 50 wt %, based on the total amount of the composition.

An advantage of a composition having a total amount of solvents for the ortho-fused phenolic resole in the range from 40 to 60 wt %, preferably in the range from 40 to 50 wt %, is that the resultant composition allows particularly effective processing.

Particular preference is given to a use (as defined above, preferably as defined above as preferable or more preferable) wherein the composition comprises one or more further additives, selected from the group consisting of
acyl chlorides,
methanesulfonic acid,
aromatic hydrocarbons,
adhesion promoters, preferably silanes, more preferably selected from the group consisting of aminosilanes, epoxysilanes, mercaptosilanes and ureidosilanes,
   and
esters of phosphoric acid.

Further additives used may also include hydrophobizing agents, such as aminosilanes and amidosilanes, for example, or flowability improvers, such as vegetable oil monoalkyl esters and tetraethyl silicate, for example.

A composition with the further additives described above leads advantageously to an extension to the sand life of the resultant composition.

The invention also relates to the use of a two-component binder system consisting of
a composition as defined above (preferably as defined above as preferable) as phenolic resin component,
   and, spatially separate therefrom,
a polyisocyanate component
   for producing feeder elements by the cold box process.

The inventive use of a two-component binder system (which produces, by reaction of its components, a polyurethane) leads to feeder elements having sufficient flexural strength and reduced emission of pollutants on casting; the advantages discussed above and below for the inventive use of a composition, and the advantages discussed below for methods and uses according to the invention, are valid accordingly.

Particular preference is also given to a use as defined above (preferably as defined above as preferable or more preferable) wherein the feeder elements comprise one or more of the following materials (a), (b), (c) and (d):

(a) one or more refractory fillers, the one or at least one of the two or more refractory fillers being selected from the group consisting of chamotte, hollow-sphere corundum, spheres of flyashes, rice husk ashes, in particular calcined rice husk ash, expanded glasses, foamed glasses, expanded perlites, core-shell particles and refractory lightweight fillers, another of the two or more refractory fillers preferably being sand, more preferably quartz sand,
the one or at least one of the two or more refractory fillers preferably being selected from the group consisting of rice husk ashes, expanded glasses, foamed glasses, expanded perlites, core-shell particles and refractory lightweight fillers,
the one or at least one of the two or more refractory fillers being more preferably selected from the group consisting of
   core-shell particles
and
   refractory lightweight fillers, preferably refractory lightweight fillers having a bulk density in the range from 10 to 600 g/L, more preferably refractory lightweight fillers having a bulk density in the range from 50 to 300 g/L,
      (b) one or more metallic or semimetallic materials,
      the one or at least one of the two or more metallic or semimetallic materials being preferably selected from the group consisting of aluminum, magnesium and silicon (alloys and mixtures of said materials comprising two or more of these materials; the use of such alloys and/or mixtures is preferable in some cases),
      (c) one or more oxidants,
      the one or at least one of the two or more oxidants being preferably selected from the group consisting of iron oxides, manganese dioxide and nitrates,
      and
      (d) one or more ignitors,
      the one or at least one of the two or more ignitors being selected from the group consisting of barium sulfate, spodumene, cordierite, andalusite, sillimanite, kyanite, nepheline, feldspar, one or more phyllosilicates.

For the production of feeders for the casting of iron and steel, and hence in particular for the production of exothermic feeders, preference is given to core-shell particles and refractory lightweight fillers as refractory fillers; cf. in each case the prior art indicated above.

For the production of feeders for the casting of aluminum, and hence in particular for the production of insulating feeders, preference is given to calcined rice husk ash, expanded glasses and expanded perlites as refractory fillers.

Particularly preferred phyllosilicates for use as ignitors are spodumene, cordierite and feldspar.

Specific refractory fillers recited above (specific materials of group (a)), such as rice husk ash, expanded glasses or core-shell particles, for example, may be refractory lightweight fillers or, indeed, refractory lightweight fillers having a bulk density in the range from 10 to 600 g/L or in the range from 50 to 300 g/L. The meanings of the terms used by the skilled person and utilized above overlap one another to some extent.

“Core-shell particles” are, for example and in particular, particles as described in EP 2 139 626 B1. “Refractory lightweight fillers” are, for example and in particular, composite particles as described in the German patent application with the official file reference DE 10 2015 120 866.

The term “refractory fillers” identifies fillers designated as “refractory” in accordance with DIN 51060.

The term “refractory lightweight fillers” refers to refractory fillers which have a bulk density of less than 800 g/L; preferred ranges of bulk densities are 10 to 750 g/L, more preferably 10 to 600 g/L, especially preferably 50 to 500 g/L, particularly preferably 50-350 g/L, and more particularly 50 to 300 g/L; for particularly preferred bulk densities, see also above.

The term “metallic or semimetallic materials” encompasses, for example and in particular, those semimetallic or metallic materials (e.g., pure metals or alloys) which can be used as reducing agents in an aluminothermic reaction or other highly exothermic redox reaction, with the oxidizing agent or agents being reduced. Oxidizing agents frequently used for this reaction (in the context of the present invention as well) are iron oxides, manganese dioxides and various metal nitrates. In the redox reaction, these oxidizing agents are reduced generally to the corresponding metals (e.g., iron or manganese). To ignite the redox reaction, which occurs, for example, at a temperature in the range from 800° C. to 1400° C., it is usual to use “ignitors”. Particularly preferred ignitors are those which when ignited and in suitable concentration deliver sufficient heat to initiate the redox reaction; preferred examples are stated above. Suitable concentrations of ignitor will be ascertained by the skilled person, using preliminary tests.

In order to initiate an aluminothermic reaction or other highly exothermic redox reaction, and to maintain it during casting, materials of groups (b) and (c) must be adapted, physically and quantitatively, to the mode of casting intended for the feeder produced. The skilled person will determine unified mixtures by means of a preliminary test. In so doing, the skilled person will bear in mind in particular that the materials (b) and (c) ought to be finely divided and distributed homogeneously in the feed.

By means of the inventive use of a composition as described above, it is possible to produce exothermic feeds which, on casting of the metal melt, lead to surprisingly lower emission of pollutants by comparison with compositions known from the prior art for exothermic feeds, while retaining good mechanical properties. With the inventive use of a composition as described above (preferably as described above as preferable), it is possible for the first time to unite good mechanical properties and low pollutant emissions. This is so in particular for the use of compositions which, as first solvent for the ortho-fused phenolic resole, comprise at least 35 wt % of alkyl silicate, preferably tetraethyl silicate, and up to 10 wt % of a further solvent, which is preferably a “dibasic ester” (i.e., a mixture of dimethyl esters of C₄ to C₆ dicarboxylic acids). The weight figures here are based in each case on the total mass of the composition used in accordance with the invention.

Particular preference is given to an inventive use (as defined above, preferably as identified above as preferable) wherein the feeder element
(i) comprises one or more metallic or semimetallic materials, the one or at least one of the two or more metallic or semimetallic materials being preferably selected from the group consisting of aluminum, magnesium and silicon
   and
   the bulk density of a mixture of all of the solids used for producing the feeder element being 2 g/cm³ or less, preferably 1.6 g/cm³ or less, more preferably 1.2 g/cm³ or less and very preferably in the range from 1 to 2 g/cm³,
      or
(ii) does not comprise aluminum, magnesium and silicon, and preferably does not comprise metallic or semimetallic materials,
   and
      the bulk density of a mixture of all of the solids used for producing the feeder element being 1 g/cm³ or less, preferably 0.8 g/cm³ or less, more preferably 0.7 g/cm³ or less and very preferably in the range from 0.4 to 1 g/cm³. The above-described “mixture of all of the solids used for producing the feeder element” is preferably a molding mixture which is used for producing a feeder element.

Depending on the mixture used, different feeders are produced, more particularly exothermic feeders (cf. embodiment (i)) or insulating feeders (cf. embodiment (ii)).

Exothermic feeders on casting normally lead to particularly high pollutant emissions, such as odor or fume emissions, for example, because of the exothermic redox reaction which is established. The inventive use of a composition or of a two-component binder system as specified above and in the claims for producing feeder elements by the cold box process is therefore particularly useful for reducing the emissions from exothermic feeder elements.

A particularly preferred bulk density of a mixture of all of the solids used for producing an exothermic feeder element is in the range from 1 to 1.6 g/cm³ and very preferably in the range from 1 to 1.2 g/cm³.

The inventive use of a composition or of a two-component binder system as specified above and in the claims for producing feeder elements (especially insulating feeder elements) by the cold box process is particularly useful for reducing the emission of fumes.

A particularly preferred bulk density of a mixture of all of the solids used for producing an insulating feeder element is in the range from 0.4 to 0.8 g/cm³ and very preferably in the range from 0.4 to 0.7 g/cm³.

The invention also relates to a method for producing a feeder element for the foundry industry, comprising the following steps:
producing or providing a molding mixture for a feeder element,
producing or providing the components of a two-component binder system of the invention as defined above,
   or
producing or providing a composition of the invention as defined above and also a polyisocyanate component, as spatially separate components of a two-component binder system,
mixing the molding mixture produced or provided with the produced or provided components of the two-component binder system,
molding the resulting mixture to give an uncured feeder element,
   and
curing the feeder element according to the cold box process, preferably by gassing with an organic amine.

With regard to all of the embodiments of a method of the invention, the explanations given above for the inventive use are valid correspondingly.

The shaping of the resulting mixture to form an uncured feeder element takes place generally in a core shooting machine.

The curing of the feeder element is carried out preferably by gassing with an organic amine, frequently in a so-called core box.

It will be appreciated that a method of the invention is more particularly a method for producing a feeder element for the foundry industry with reduced emissions in the casting operation.

Also preferred is a method as defined above wherein the molding mixture comprises one or more of the following materials

(a) one or more refractory fillers, the one or at least one of the two or more refractory fillers being selected from the group consisting of chamotte, hollow-sphere corundum, spheres of flyashes, rice husk ashes, expanded glasses, foamed glasses, expanded perlites, core-shell particles and refractory lightweight fillers, another of the two or more refractory fillers preferably being sand, more preferably quartz sand,
the one or at least one of the two or more refractory fillers preferably being selected from the group consisting of rice husk ashes, expanded glasses, foamed glasses, expanded perlites, core-shell particles and refractory lightweight fillers,
the one or at least one of the two or more refractory fillers being more preferably selected from the group consisting of
core-shell particles
   and
refractory lightweight fillers, preferably refractory lightweight fillers having a bulk density in the range from 10 to 600 g/L, more preferably refractory lightweight fillers having a bulk density in the range from 50 to 300 g/L,
   (b) one or more metallic or semimetallic materials,
   the one or at least one of the two or more metallic or semimetallic materials being preferably selected from the group consisting of aluminum, magnesium and silicon,
   (c) one or more oxidants,
   the one or at least one of the two or more oxidants being preferably selected from the group consisting of iron oxides, manganese dioxide and nitrates,
   and
   (d) one or more ignitors,
   the one or at least one of the two or more ignitors being selected from the group consisting of barium sulfate, spodumene, cordierite, andalusite, sillimanite, kyanite, nepheline, feldspar, one or more phyllosilicates.

Particularly preferred phyllosilicates for use as ignitors are spodumene, cordierite and feldspar.

With regard to all of the embodiments of a method of the invention as described above as preferable, the explanations given above for the inventive use are valid correspondingly.

Particular preference is given to a method of the invention (preferably as designated above as preferable) wherein the molding mixture
(i) comprises one or more metallic or semimetallic materials, the one or at least one of the two or more metallic or semimetallic materials being preferably selected from the group consisting of aluminum, magnesium and silicon
   and
   the bulk density of the molding mixture being 2 g/cm³ or less, preferably 1.6 g/cm³ or less, more preferably 1.2 g/cm³ or less and very preferably in the range from 1 to 2 g/cm³,
      or
(ii) does not comprise aluminum, magnesium and silicon, and preferably does not comprise metallic or semimetallic materials,
   and
   the bulk density of the molding mixture being 1 g/cm³ or less, preferably 0.8 g/cm³ or less, more preferably 0.7 g/cm³ or less and very preferably in the range from 0.6 to 1 g/cm³.

With regard to all of the embodiments of a method of the invention as described above as more preferable, the explanations given above for the inventive use are valid correspondingly.

In particular, with regard to preferred embodiments of a method of the invention for producing an exothermic (item (i)) or insulating (item (ii)) feeder element, the explanations given for the inventive use for producing exothermic (item (i)) or insulating (item (ii)) feeder elements by the cold box process are valid correspondingly.

The invention also relates to a feeder element producible by a method of the invention, wherein the feeder element
(i) comprises metallic or semimetallic materials (b), preferably additionally the materials (c) and/or (d), and possesses a density in the range from 1.0 to 2.0 g/cm³, preferably a density in the range from 1.0 to 1.6 g/cm³, more preferably a density in the range from 1.0 to 1.2 g/cm³,
   or
(ii) comprises one or more refractory fillers (a) and possesses a density in the range from 0.6 to 1.0 g/cm³, preferably a density in the range from 0.6 to 0.8 g/cm³, more preferably a density in the range from 0.6 to 0.7 g/cm³.

A feeder element of the invention is identifiable by analysis of the cured binder system it comprises, optionally by comparison with reference feeder elements for which the total fraction of alkyl silicates, alkyl silicate oligomers and mixtures thereof used is known.

Depending on the selection of the constituents of the molding mixture and of the production method used, a feeder element of the invention may be
an exothermic feeder element
   or
an insulating feeder element.

With regard to preferred embodiments of a feeder element of the invention, the explanations given for the method of the invention and for the inventive use are valid correspondingly.

In particular, with regard to preferred embodiments of an exothermic or insulating feeder element of the invention, the explanations given for the method of the invention for producing an exothermic or insulating feeder element and for the inventive use for producing exothermic or insulating feeder elements by the cold box process are valid correspondingly.

Feeders of the invention as described above are notable in particular for their particularly low emissions of CO₂ and fumes during casting of the metal melt.

Insulating feeders of the invention as described above have the advantage, moreover, that they are particularly light and therefore make it more convenient to use the feeder in practice.

### DESCRIPTION OF THE FIGURES

FIG. 1: burning of a feeder element produced according to the feeder formulation “Standard” in table 1 (see below).

FIG. 2: burning of a feeder element produced according to the feeder formulation “HA 2” in table 1 (see below).

### EXAMPLES

The examples below are intended to elucidate the invention without limiting it.

The abbreviation “pbw” used in the examples denotes parts by weight (parts by mass).

Concerning the measurement method used for the flexural strength after 24 hours (“flexural strength 24 h”):

The flexural strength was determined in a method based on German VDG standard P 73, method A (type of mixer used: BOSCH Profi 67, processing at room temperature and ambient humidity, production by ramming, capture of test values after 1 h and after 24 h, triplicate determination in each case) using the PFG strength testing apparatus with low-pressure manometer N (with motor drive).

### Examples 1 to 3 were Carried Out in Close Alignment with Examples 1 to 3 of Document EP 1 057 554 B1

### Example 1: Preparation of a Phenolic Resin (Precondensate)

A reaction vessel equipped with condenser, thermometer and stirrer was charged with
385.0 pbw of phenol (pure)
176.0 pbw of paraformaldehyde (91 percent form; as formaldehyde source)
and
0.11 pbw of zinc acetate decahydrate.

The condenser was set to reflux. The temperature was raised continuously over the course of an hour to bring it to 105° C. and was maintained at this temperature for two to three hours until a refractive index of 1.550 was reached.

The condenser was then changed over to atmospheric distillation and the temperature was increased over the course of an hour to 125-126° C., until a refractive index of about 1.593 was reached. This was followed by vacuum distillation until the refractive index was 1.612. The yield amounted to around 82-83% of the raw materials used.

### Example 2: Preparation of Cold Box Phenolic Resin Solutions

Resin solutions for the cold box process were prepared from the phenolic resin (precondensate) according to example 1, after attainment of the target refractive index value, these solutions having the compositions as indicated below:

Cold box resin solutions gas resins EX-1 to EX-5
Gas resin EX-1
55 pbw of phenolic resin (precondensate)
30 pbw of tetraethyl silicate
14.7 pbw of DBE® (trade name “Dibasic Ester” from DuPont)
0.3 pbw of aminosilane or amidosilane
Note: gas resin EX-1 corresponds to “resin solution HA 1” from example 2 of EP 1 057 554 B1
   Gas resin EX-2
55 pbw of phenolic resin (precondensate)
35 pbw of tetraethyl silicate
9.7 pbw of DBE® (trade name “Dibasic Ester” from DuPont)
0.3 pbw of aminosilane or amidosilane
Note: gas resin EX-2 corresponds to “resin solution HA 2” from example 2 of EP 1 057 554 B1
   Gas resin EX-3
55 pbw of phenolic resin (precondensate)
15 pbw of tetraethyl silicate
29.7 pbw of DBE® (trade name “Dibasic Ester” from DuPont)
0.3 pbw of aminosilane or amidosilane
Note: gas resin EX-3 corresponds to “resin solution HA 3” from example 2 of EP 1 057 554 B1
   Gas resin EX-4
55 pbw of phenolic resin (precondensate)
1 pbw of tetraethyl silicate
43.7 pbw of DBE® (trade name “Dibasic Ester” from DuPont)
0.3 pbw of aminosilane or amidosilane
Note: gas resin EX-4 corresponds to “resin solution HA 4” from example 2 of EP 1 057 554 B1
   Gas resin EX-5
55 pbw of phenolic resin (precondensate)
5 pbw of tetraethyl silicate
44.7 pbw of DBE® (trade name “Dibasic Ester” from DuPont)
0.3 pbw of aminosilane or amidosilane
Note: gas resin EX-5 corresponds to “resin solution HA 5” from example 2 of EP 1 057 554 B1
   Conventionally for comparison: GAS RESIN EX-6
54.2 pbw of phenolic resin (precondensate)
24.0 pbw of DBE
21.5 pbw of RME (rapeseed oil methyl ester)
0.3 pbw of aminosilane or amidosilane

### Example 3: Preparation of Polyisocyanate Solutions for the Cold Box Process

Additionally, polyisocyanate solutions (“ACTIVATOR EY-1” and “ACTIVATOR EY-2”) were prepared for the cold box process, these solutions having the compositions indicated below:

### ACTIVATOR EY-1

85.0 pbw of diphenylmethane diisocyanate
14.7 pbw of RME (rapeseed oil methyl ester)
0.3 pbw of acyl chloride (additive for extending the sand life)

### ACTIVATOR E-Y2

80.0 pbw of diphenylmethane diisocyanate
9.4 pbw of tetraethyl silicate
9.0 pbw of dioctyl adipate
1.4 pbw of additive EZ-1 from PCT/EP2012/072705 (additive for extending the sand life)

### Example 4: Production of Cold-Box-Bound Feeder Test Specimens

The molding sand mixtures listed in table 1 below were produced and mixed with the above-specified phenolic resin solutions and polyisocyanate solutions (cf. examples 2 and 3) to give the resulting feeder formulations “standard”, “HA1”, “HA2”, “HA3”, “HA4” and “HA5”.

TABLE 1
Feeder formulations of the cold-box-bound feeder test specimens

| Feeder formulation | | Standard | HA1 | HA2 | HA3 | HA4 | HA5 |
|---|---|---|---|---|---|---|---|
| Molding | Spray-atomized aluminum | 26 | 26 | 26 | 26 | 26 | 26 |
| sand | powder (pbw) | | | | | | |
| mixtures | Cordierite (pbw) | 3 | 3 | 3 | 3 | 3 | 3 |
| | Iron oxide (pbw) | 9 | 9 | 9 | 9 | 9 | 9 |
| | Potassium nitrate (pbw) | 17 | 17 | 17 | 17 | 17 | 17 |
| | Chamotte (pbw) | 18 | 18 | 18 | 18 | 18 | 18 |
| | Core-shell particles (pbw) | 27 | 27 | 27 | 27 | 27 | 27 |
| Activator | ACTIVATOR EY-1 (pbw) | 4.5 | — | — | — | — | — |
| | ACTIVATOR EY-2 (pbw) | — | 4.5 | 4.5 | 4.5 | 4.5 | 4.5 |
| Gas resin | GAS RESIN EX-6 (pbw) | 4.5 | — | — | — | — | — |
| | GAS RESIN EX-1 (pbw) | — | 4.5 | — | — | — | — |
| | GAS RESIN EX-2 (pbw) | — | — | 4.5 | — | — | — |
| | GAS RESIN EX-3 (pbw) | — | — | — | 4.5 | — | — |
| | GAS RESIN EX-4 (pbw) | — | — | — | — | 4.5 | — |
| | GAS RESIN EX-5 (pbw) | — | — | — | — | — | 4.5 |

Subsequently, the “flexural strengths 24 h” of the feeder test specimens produced in accordance with the feeder formulations of table 1 (correspondingly in each case: “standard”, “HA1”, “HA2”, “HA3”, “HA4” and “HA5”; cf. table 2) were determined by the GF method. In the production of the feeder test specimens and the testing thereof for their flexural strengths (regarding the method, see above), the protocols of the VDG fact sheet P 73 of February 1996 were observed. The results of the testing are set out in table 2. The values for the “flexural strengths 24 h” of the feeder test specimens produced (corresponding in each case to the feeder formulation used: “S-standard”, “S-HA1”, “S-HA2”, “S-HA3”, “S-HA4” and “S-HA5”; cf. table 2) correspond to average values from two triplicate determinations. The “target value” of “at least 350” is additionally entered in table 2, and corresponds to a value, customarily required in practice, for flexural strengths of a test specimen for exothermic feeder elements.

TABLE 2
Measurement values for the “flexural strengths 24 h” as per VDG fact sheet P 73

| Feeder test specimen | Target value | S-standard | S-HA1 | S-HA2 | S-HA3 | S-HA4 | S-HA5 |
|---|---|---|---|---|---|---|---|
| Flexural strength | at least 350 | 370 | 340 | 380 | 250 | 270 | 300 |
| 24 h [N/cm²] | | | | | | | |

Surprisingly, therefore, “HA 2” (comprising GAS RESIN EX-2 with a fraction of 35 pbw of tetraethyl silicate) is the only feeder formulation according table 1 for producing an exothermic feeder element (see correspondingly “S-HA2” in table 2) that leads to a flexural strength (elasticity) on the part of the test specimens that lies above the target value. Another reason why this finding is surprising is that according to table 2a of document EP 1 057 554 B1, cores (“test specimens”) produced using “resin solution HA 1” (the formulation is identical to that of gas resin EX-1) gave the highest flexural strengths 24 h.

It is surprising, moreover, that the feeder formulations “HA 1” and “HA 3” to “HA 5” do not lead to reasonable feeder flexural strengths that are acceptable in practice (minimum flexural strength requirement of at least 350 N/cm²; see target value in table 2), whereas according to EP 1 057 554 B1, table 2a, all of the resin solutions HA 1 to HA 5 stated therein (the formulations of which are each identical to those of gas resin EX-1 to gas resin EX-5) produced test specimens having sufficient flexural strengths for cores.

### Example 5: Emissions Test (Reducing the Emission of CO₂)

When using a feeder according to formulation “HA 2”, it was possible, in comparison to a feeder according to formulation “standard” (cf. example 4, table 1), to ascertain a lowering by 2% of the emission values in the form of CO₂.

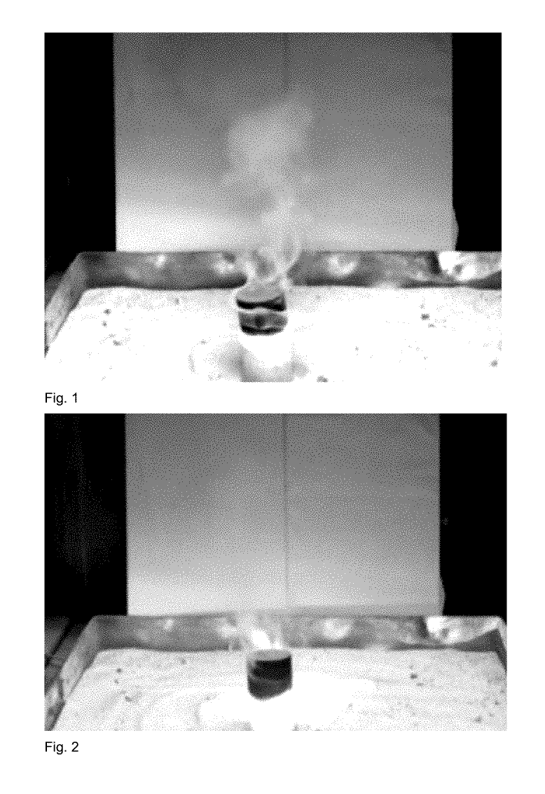

On burning of the feeder “HA 2” (cf. FIG. 2), it was possible, moreover, to see a reduced evolution of fumes by comparison with the “standard” feeder (cf. FIG. 1).

Examples 4 and 5 above relate to exothermic feeders and feeder formulations for producing exothermic feeders, respectively. In studies designed correspondingly for insulating feeders and feeder formulas for producing insulating feeders, respectively, GAS RESIN EX-2, with a tetraethyl silicate fraction of 35 pbw, was likewise found to be the binder component which led to the best results in relation to flexural strength and emission reduction.

1. Method for producing feeder elements by the cold box process, comprising:
using a composition comprising
an ortho-fused phenolic resole in an amount of up to 60 wt %,
as first solvent for the ortho-fused phenolic resole, one or more compounds selected from the group consisting of alkyl silicates, alkyl silicate oligomers and mixtures thereof, the total amount of these compounds being greater than 30 wt %,
optionally one or more further solvents for the ortho-fused phenolic resole,
optionally one or more further additives,
the weight percentages being based on the total amount of the composition,
as a binder component for producing feeder elements by the cold box process.

2. The method as claimed in claim 1, wherein the composition comprises
as first solvent for the ortho-fused phenolic resole, one or more compounds selected from the group consisting of alkyl silicates, alkyl silicate oligomers and mixtures thereof, the total amount of these compounds being greater than 30 wt %,
optionally one or more further solvents for the ortho-fused phenolic resole, and
optionally one or more further additives,
the ratio by mass of the total amount of first solvent to the total amount of further solvents and further additives being at least greater than 1, preferably at least greater than 2.

3. The method as claimed in claim 1, wherein the composition comprises
as first solvent for the ortho-fused phenolic resole, one or more alkyl silicates, the total amount of these alkyl silicates being being greater than than 30 wt % and preferably being 35 wt % or more, based on the total amount of the composition,
and preferably
as first solvent for the ortho-fused phenolic resole, one or more tetraalkyl silicates, the total amount of these tetraalkyl silicates being greater than 30 wt % and preferably being 35 wt % or more, based on the total amount of the composition.

4. The method as claimed in claim 1, wherein the composition comprises
as first solvent for the ortho-fused phenolic resole, tetraethyl silicates, the total amount of these tetraethyl silicates being greater than 30 wt % and preferably being at least 35 wt % or more, based on the total amount of the composition.

5. The method as claimed in claim 1, wherein the composition comprises
the ortho-fused phenolic resole in an amount of 40 to 60 wt %, preferably 50 to 60 wt %, based on the total amount of the composition.

6. The method as claimed in claim 1, wherein the composition comprises one or more further solvents for the ortho-fused phenolic resole, selected from the group consisting of
mixtures of dialkyl esters of C₂ to C₆ dicarboxylic acids, preferably of dimethyl esters of C₄ to C₆ dicarboxylic acids,
monoesters of fatty acids with a carbon chain of 12 or more C atoms, preferably alkyl monoesters, more preferably methyl monoesters and/or butyl monoesters,
and
propylene carbonate.

7. The method as claimed in claim 1, wherein the composition comprises a total amount of solvents for the ortho-fused phenolic resole in the range from 40 to 60 wt %, preferably a total amount in the range from 40 to 50 wt %, based on the total amount of the composition.

8. The method as claimed in claim 1, wherein the composition comprises one or more further additives, selected from the group consisting of
acyl chlorides,
methanesulfonic acid,
aromatic hydrocarbons,
adhesion promoters, preferably silanes, more preferably selected from the group consisting of aminosilanes, epoxysilanes, mercaptosilanes and ureidosilanes,
and
esters of phosphoric acid.

9. A method of producing feeder elements by the cold box process, comprising:
using a two-component binder system consisting of
a composition as defined in any of the preceding claims, as phenolic resin component,
and, spatially separate therefrom,
a polyisocyanate component
for producing feeder elements by the cold box process.

10. The method as claimed in claim 1, wherein the feeder elements comprise one or more of the following materials (a), (b), (c) and (d):
(a) one or more refractory fillers, the one or at least one of the two or more refractory fillers being selected from the group consisting of chamotte, hollow-sphere corundum, spheres of flyashes, rice husk ashes, expanded glasses, foamed glasses, expanded perlites, core-shell particles and refractory lightweight fillers, another of the two or more refractory fillers preferably being sand, more preferably quartz sand, the one or at least one of the two or more refractory fillers preferably being selected from the group consisting of rice husk ashes, expanded glasses, foamed glasses, expanded perlites, core-shell particles and refractory lightweight fillers,
the one or at least one of the two or more refractory fillers being more preferably selected from the group consisting of
core-shell particles
and
refractory lightweight fillers, preferably refractory lightweight fillers having a bulk density in the range from 10 to 600 g/L, more preferably refractory lightweight fillers having a bulk density in the range from 50 to 300 g/L,
(b) one or more metallic or semimetallic materials,
the one or at least one of the two or more metallic or semimetallic materials being preferably selected from the group consisting of aluminum, magnesium and silicon,
(c) one or more oxidants,
the one or at least one of the two or more oxidants being preferably selected from the group consisting of iron oxides, manganese dioxide and nitrates,
and
(d) one or more ignitors,
the one or at least one of the two or more ignitors being selected from the group consisting of barium sulfate, spodumene, cordierite, andalusite, sillimanite, kyanite, nepheline, feldspar, one or more phyllosilicates.

11. The method as claimed in claim 10, wherein the feeder element
(i) comprises one or more metallic or semimetallic materials, the one or at least one of the two or more metallic or semimetallic materials being preferably selected from the group consisting of aluminum, magnesium and silicon
and
the bulk density of a mixture of all of the solids used for producing the feeder element being 2 g/cm³ or less, preferably 1.6 g/cm³ or less, more preferably 1.2 g/cm³ or less and very preferably in the range from 1 to 2 g/cm³,
or
(ii) does not comprise aluminum, magnesium and silicon, and preferably does not comprise metallic or semimetallic materials,
and
the bulk density of a mixture of all of the solids used for producing the feeder element being 1 g/cm³ or less, preferably 0.8 g/cm³ or less, more preferably 0.7 g/cm³ or less and very preferably in the range from 0.4 to 1 g/cm³.

12. The method according to claim 1, further comprising:
producing or providing a molding mixture for a feeder element,
producing or providing the components of a two-component binder system consisting of:
a composition as defined in any of the preceding claims, as phenolic resin component,
and, spatially separate therefrom,
a polyisocyanate component,
mixing the molding mixture produced or provided with the produced or provided components of the two-component binder system,
molding the resulting mixture to give an uncured feeder element,
and
curing the feeder element according to the cold box process.

13. The method as claimed in claim 12, wherein the molding mixture comprises one or more of the following materials
(a) one or more refractory fillers, the one or at least one of the two or more refractory fillers being selected from the group consisting of chamotte, hollow-sphere corundum, spheres of flyashes, rice husk ashes, expanded glasses, foamed glasses, expanded perlites, core-shell particles and refractory lightweight fillers, another of the two or more refractory fillers preferably being sand, more preferably quartz sand, the one or at least one of the two or more refractory fillers preferably being selected from the group consisting of rice husk ashes, expanded glasses, foamed glasses, expanded perlites, core-shell particles and refractory lightweight fillers,
the one or at least one of the two or more refractory fillers being more preferably selected from the group consisting of
core-shell particles
and
refractory lightweight fillers, preferably refractory lightweight fillers having a bulk density in the range from 10 to 600 g/L, more preferably refractory lightweight fillers having a bulk density in the range from 50 to 300 g/L,
(b) one or more metallic or semimetallic materials,
the one or at least one of the two or more metallic or semimetallic materials being preferably selected from the group consisting of aluminum, magnesium and silicon,
(c) one or more oxidants,
the one or at least one of the two or more oxidants being preferably selected from the group consisting of iron oxides, manganese dioxide and nitrates,
and
(d) one or more ignitors,
the one or at least one of the two or more ignitors being selected from the group consisting of barium sulfate, spodumene, cordierite, andalusite, sillimanite, kyanite, nepheline, feldspar, one or more phyllosilicates.

14. The method as claimed in claim 13, wherein the molding mixture
(i) comprises one or more metallic or semimetallic materials, the one or at least one of the two or more metallic or semimetallic materials being preferably selected from the group consisting of aluminum, magnesium and silicon
and
the bulk density of the molding mixture being 2 g/cm³ or less, preferably 1.6 g/cm³ or less, more preferably 1.2 g/cm³ or less and very preferably in the range from 1 to 2 g/cm³,
or
(ii) does not comprise aluminum, magnesium and silicon, and preferably does not comprise metallic or semimetallic materials,
and
the bulk density of the molding mixture being 1 g/cm³ or less, preferably 0.8 g/cm³ or less, more preferably 0.7 g/cm³ or less and very preferably in the range from 0.6 to 1 g/cm³.

15. A feeder element producible by a method as claimed in claim 13, wherein the feeder element
(i) comprises metallic or semimetallic materials (b), preferably additionally the materials (c) and/or (d), and possesses a density in the range from 1.0 to 2.0 g/cm³, preferably a density in the range from 1.0 to 1.6 g/cm³, more preferably a density in the range from 1.0 to 1.2 g/cm³,
or
(ii) comprises one or more refractory fillers (a) and possesses a density in the range from 0.6 to 1.0 g/cm³, preferably a density in the range from 0.6 to 0.8 g/cm³, more preferably a density in the range from 0.6 to 0.7 g/cm³.

16. The method according to claim 9, further comprising:
producing or providing a molding mixture for a feeder element,
producing or providing a binder component composition and also a polyisocyanate component, as spatially separate components of a two-component binder system, wherein the binder component composition comprises:
an ortho-fused phenolic resole in an amount of up to 60 wt %,
as first solvent for the ortho-fused phenolic resole, one or more compounds selected from the group consisting of alkyl silicates, alkyl silicate oligomers and mixtures thereof, the total amount of these compounds being greater than 30 wt %,
optionally one or more further solvents for the ortho-fused phenolic resole,
optionally one or more further additives,
the weight percentages being based on the total amount of the binder component,
mixing the molding mixture produced or provided with the produced or provided components of the two-component binder system,
molding the resulting mixture to give an uncured feeder element, and
curing the feeder element according to the cold box process.

17. The method as claimed in claim 16, wherein the molding mixture comprises one or more of the following materials
(a) one or more refractory fillers, the one or at least one of the two or more refractory fillers being selected from the group consisting of chamotte, hollow-sphere corundum, spheres of flyashes, rice husk ashes, expanded glasses, foamed glasses, expanded perlites, core-shell particles and refractory lightweight fillers, another of the two or more refractory fillers preferably being sand, more preferably quartz sand, the one or at least one of the two or more refractory fillers preferably being selected from the group consisting of rice husk ashes, expanded glasses, foamed glasses, expanded perlites, core-shell particles and refractory lightweight fillers,
the one or at least one of the two or more refractory fillers being more preferably selected from the group consisting of
core-shell particles
and
refractory lightweight fillers, preferably refractory lightweight fillers having a bulk density in the range from 10 to 600 g/L, more preferably refractory lightweight fillers having a bulk density in the range from 50 to 300 g/L,
(b) one or more metallic or semimetallic materials,
the one or at least one of the two or more metallic or semimetallic materials being preferably selected from the group consisting of aluminum, magnesium and silicon,
(c) one or more oxidants,
the one or at least one of the two or more oxidants being preferably selected from the group consisting of iron oxides, manganese dioxide and nitrates,
and
(d) one or more ignitors,
the one or at least one of the two or more ignitors being selected from the group consisting of barium sulfate, spodumene, cordierite, andalusite, sillimanite, kyanite, nepheline, feldspar, one or more phyllosilicates.

18. The method as claimed in claim 16, wherein the molding mixture
(i) comprises one or more metallic or semimetallic materials, the one or at least one of the two or more metallic or semimetallic materials being preferably selected from the group consisting of aluminum, magnesium and silicon
and
the bulk density of the molding mixture being 2 g/cm³ or less, preferably 1.6 g/cm³ or less, more preferably 1.2 g/cm³ or less and very preferably in the range from 1 to 2 g/cm³,
or
(ii) does not comprise aluminum, magnesium and silicon, and preferably does not comprise metallic or semimetallic materials,
and
the bulk density of the molding mixture being 1 g/cm³ or less, preferably 0.8 g/cm³ or less, more preferably 0.7 g/cm³ or less and very preferably in the range from 0.6 to 1 g/cm³.

19. A feeder element producible by a method as claimed in claim 16, wherein the feeder element
(i) comprises metallic or semimetallic materials (b), preferably additionally the materials (c) and/or (d), and possesses a density in the range from 1.0 to 2.0 g/cm³, preferably a density in the range from 1.0 to 1.6 g/cm³, more preferably a density in the range from 1.0 to 1.2 g/cm³,
or
(ii) comprises one or more refractory fillers (a) and possesses a density in the range from 0.6 to 1.0 g/cm³, preferably a density in the range from 0.6 to 0.8 g/cm³, more preferably a density in the range from 0.6 to 0.7 g/cm³.
